(19) United States
(12) Patent Application Publication
(10) Pub. No.: US 2026/0233697 A1
(43) Pub. Date: Aug. 13, 2026

(54) BODY ARRANGEMENT WITH IMPROVED PEDESTRIAN PROTECTION AND VEHICLE

(71) Applicant: AUDI AG, Ingolstadt (DE)

(72) Inventors: Enrico VOGELSANG, Tübingen (DE); Kathrin SCHERLE, Asbach-Bäumenheim (DE); Christian TEICHMANN, Eitensheim (DE)

(73) Assignee: AUDI AG, Ingolstadt (DE)

(21) Appl. No.: 19/395,601

(22) Filed: Nov. 20, 2025

(30) Foreign Application Priority Data
Feb. 11, 2025 (DE) 102025105061.9

(51) Int. Cl. B60R 21/34; B60Q 1/04

(52) U.S. Cl. CPC B60R 21/34; B60Q 1/0491; B60R 2021/343

(57) ABSTRACT

A body arrangement for a vehicle includes at least one fender and at least one attachment part. The at least one fender and the at least one attachment part are connected to a vehicle-side structure. The fender has at least one hazardous region through which a risk of injury can be created in the event of an accident, and the at least one attachment part is arranged next to the hazardous region of the at least one fender. A connection is formed between the at least one attachment part and the at least one fender.

### FIELD

The invention relates to a body arrangement for a vehicle, comprising at least one fender and at least one attachment part, wherein the at least one fender and the at least one attachment part are connected to a vehicle-side structure. The invention further relates to a vehicle with at least one body arrangement.

### BACKGROUND

The body of a vehicle has fenders at the front of the vehicle, which form and cover the wheel wells for the front wheels. Due to the shape of the fenders, edges or tips of the fenders can protrude sideways in the event of an accident, causing deformation of the body and resulting in a risk of injury to pedestrians. This deformation of the fenders, which is unfavorable for pedestrians, can be caused by a relative movement between the main headlight and the front flap relative to the fender.

DE 29 34 060 A1, for example, describes a body that is intended to reduce the risk of injury to pedestrians through defined deformation zones.

DE 100 16 916 A1 discloses a fender for a vehicle which is fastened to a vehicle frame by means of a support element. The support element is filled with an electro-rheological fluid, which allows the mounting of the fender to be set to be rigid or elastic.

EP 1 457 393 A1 describes a fender and a front hood of a vehicle with deformation bases and deformation consoles in order to achieve soft impact behavior in the event of an accident involving a pedestrian.

EP 1 892 162 A2 proposes a flexible connection between a fender and a vehicle frame in order to achieve a defined deformation of the fender in the event of a collision with a pedestrian.

### SUMMARY

It is the object of the present invention to provide a body arrangement and a vehicle that can minimize the risk of injury to pedestrians in the event of an accident.

This object is achieved according to the invention by a body arrangement and by a vehicle.

According to one aspect of the invention, a body arrangement for a vehicle is provided. The body arrangement comprises at least one body part in the form of a fender and at least one attachment part. The at least one fender and the at least one attachment part are connected to a vehicle-side structure. Such a structure may be, for example, a support frame or vehicle frame, a supporting body structure, other body parts and the like.

The fender has at least one hazardous region which could pose a risk of injury in the event of an accident. In particular, the risk of injury may not arise in all accidents, but in some possible constellations. For example, the risk of injury may arise when unprotected persons, such as cyclists or pedestrians, are involved and the fender is deformed in an accident to such an extent that the hazardous region protrudes beyond a normal contour of the body due to deformation.

The at least one attachment part is arranged next to the hazardous region of the at least one fender. According to the invention, a connection is formed between the at least one attachment part and the at least one fender.

By mechanically coupling the fender with surrounding components or attachment parts, deformation of the fender that is unfavorable for pedestrians can be avoided. In this case, a relative movement between the at least one attachment part and the at least one fender along at least one spatial direction can be prevented since they are mechanically connected to one another.

The at least one attachment part can, for example, be connected to the hazardous region of the fender or to the fender in its neighborhood.

A vehicle is provided according to a further aspect of the invention. The vehicle has a body which is connected to a structure of the vehicle, wherein the body may also form part of this structure. The vehicle has at least one body arrangement according to the invention.

The body arrangement according to the invention can improve the safety of pedestrians in accidents involving vehicles. Due to the structural coupling of at least one fender with surrounding attachment parts, the risk of injury is significantly reduced. Avoiding relative movements between the attachment parts and the hazardous region of the fender prevents, in particular, the hazardous region from protruding. Such a hazardous region can be, for example, a pointed section of the fender, a tab, a fastening and the like, which can injure a pedestrian or get caught in the pedestrian in the event of an impact.

Furthermore, such a body arrangement can be technically easily integrated into existing vehicle designs, since no external components or externally visible components are changed.

In one exemplary embodiment, the connection between the at least one attachment part and the at least one fender is designed in the form of a form-fitting connection, a material connection or in the form of a movable connection. Thus, the connection or coupling between the attachment part and the at least one fender can be designed in a variety of ways.

The connection can be designed as a form-fitting connection. The connection designed as a form-fitting connection can be implemented by a mechanical connection, such as screwing, clamping, riveting and the like. Alternatively or additionally, the connection can be designed as a material connection. The connection, which is designed as a material connection, can be implemented, for example, by gluing or welding. Alternatively or additionally, the connection can be designed as a movable connection between the at least one attachment part and the at least one fender. The connection designed as a movable connection between the at least one attachment part and the at least one fender can be flexible. This connection can be formed, for example, by a connection using elastic materials, by joint systems and the like.

According to a further embodiment, the connection between the at least one attachment part and the at least one fender is configured to limit a relative movement between the at least one attachment part and the at least one fender in at least one spatial direction. This measure allows the resulting energy to be redirected in the event of an impact in such a way that the hazardous region of the fender is prevented from protruding.

According to a further exemplary embodiment, the form-fitting connection between the at least one attachment part and the at least one fender is permanent or temporary. A permanent connection can be formed, for example, by screwing, gluing, riveting and the like.

In the case of a temporary connection, this can be present or be effective if, for example, an attachment part designed as a front flap is in a closed state. Such a variable connection can be realized, for example, by “shoeing in” a section of the fender into a holder on the front flap, by which a relative movement of the fender and/or of the hazardous region is blocked in certain directions of movement or spatial directions. The temporary connection can be released by opening the front flap. This can, for example, prevent a hazardous region of the fender, which is designed as a fender tip, from bending vertically in the event of a pedestrian accident, but still allow the front flap to be opened for customer service.

The risk of injury can be reduced particularly effectively by the body arrangement if the hazardous region of the fender is designed as a fender tip directed in the direction of travel of the vehicle. Due to the permanent or temporary connection of the fender tip to at least one attachment part, this can be torn along or deformed if the attachment part moves relative to the fender, thus preventing the fender tip from protruding beyond the vehicle contour.

According to a further exemplary embodiment, the at least one attachment part is designed as a motor hood or a lighting device of the vehicle. This makes it particularly easy to protect at least one fender against adverse relative movement during an accident.

### BRIEF DESCRIPTION OF THE FIGURES

The invention is schematically illustrated in the drawings with the aid of embodiments and is described further with reference to the drawings. In the figures:

FIG. 1 shows a schematic side view of a vehicle with a body arrangement according to an exemplary embodiment of the invention.

FIG. 2 shows a schematic plan view of a fender illustrating a hazardous region of the fender.

FIG. 3 shows a schematic plan view of a body arrangement according to an exemplary embodiment of the invention.

Elements and components with the same or similar structural or functional features are provided with the same reference numerals throughout the figures.

### DETAILED DESCRIPTION

FIG. 1 shows a schematic side view of a vehicle 100 with a body arrangement 10 according to an exemplary embodiment of the invention. The vehicle 100 has a body 110 which is connected to a structure of the vehicle 100. The structure of the vehicle 100 in the illustrated exemplary embodiment is a support frame structure, which is not shown.

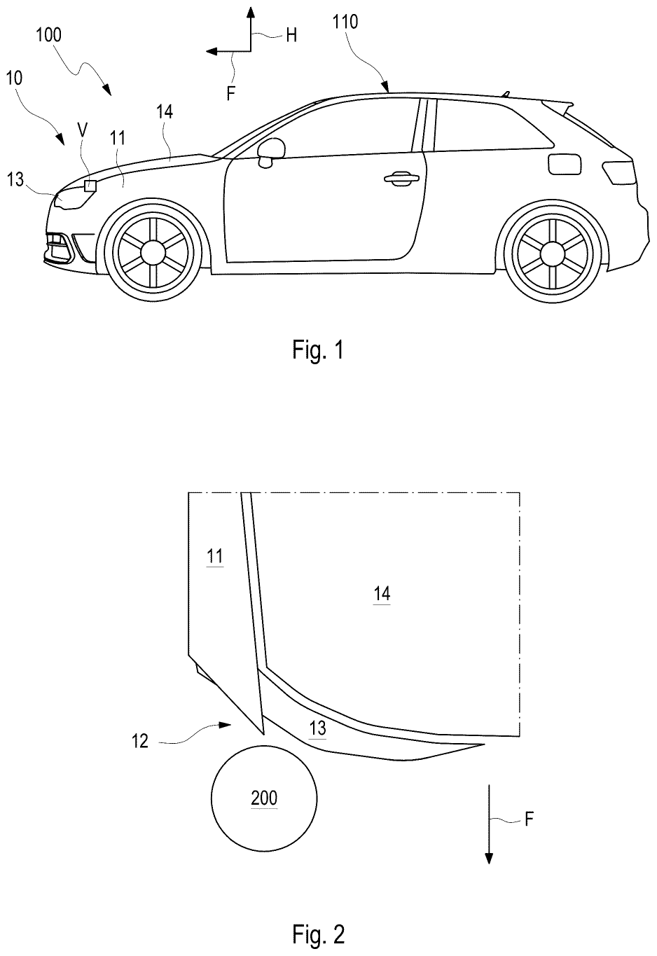

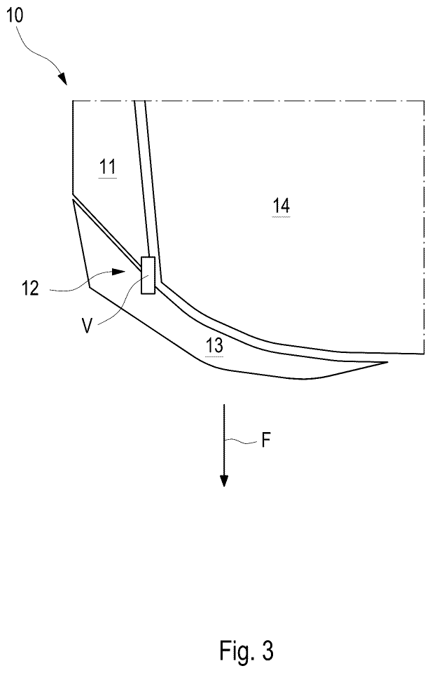

The vehicle has at least one body arrangement 10, which is shown and described in detail in FIG. 3. The body arrangement 10 is designed to reduce the risk of injury to pedestrians 200 (FIG. 2). For this purpose, FIG. 2 shows a schematic plan view of a fender 11 to illustrate a hazardous region 12 of the fender 11. Under unfavorable boundary conditions during an accident, a relative movement can occur between headlights or a lighting device 13 and the fender 11 of the vehicle 100, whereby the lighting device 13 and the fender 11 are offset from one another in the height direction H. In such a scenario, a hazardous region 12 of the fender 11, which is designed, for example, as a fender tip, may protrude and entail a particularly high risk of injury.

FIG. 3 shows a schematic plan view of a body arrangement 10 according to an exemplary embodiment of the invention, by which the occurrence of such a risk of injury is avoided. One of many possibilities for technical implementation is shown here.

The body arrangement 10 comprises at least one body part in the form of a fender 11 and at least one attachment part 13, 14. In the exemplary embodiment shown, the lighting device 13 and a front flap 14 of the vehicle 100 are provided as possible attachment parts 13, 14. The front flap 14 can be designed, for example, as a flap of a frunk or as a hood.

The at least one fender 11 and the at least one attachment part 13, 14 are connected to a vehicle-side structure. The at least one attachment part 13, 14 is arranged next to the hazardous region 12 of the fender 11. To prevent a relative movement, for example in the height direction H and/or in the direction of travel F, a connection V is or has to be formed between at least one attachment part 13, 14 and the fender 11.

In the exemplary embodiment shown, a coupling or connection V of the fender 11 with the lighting device 13 takes place. For this purpose, the fender tip or the hazardous region 12 is firmly connected to the lighting device 13 designed as a main headlight. The connection V can be designed as a form-fitting screwed connection, for example. Alternatively or additionally, a connection V can be implemented between the fender 11 and the front flap 14. Such a connection V forces a joint deformation of the hazardous region 12 with the connected attachment parts 13, 14 in the event of an impact and prevents a possible relative movement between the fender 11 and the respective attachment parts 13, 14.

### LIST OF REFERENCE NUMERALS

100 vehicle
110 body
200 pedestrian
10 body arrangement
11 fender
12 hazardous region of the fender
13 attachment part/lighting device
14 attachment part/front flap
H height direction
F direction of travel
V connection

1. A body arrangement for a vehicle, comprising: at least one fender and at least one attachment part, wherein the at least one fender and the at least one attachment part are connected to a vehicle-side structure, wherein the fender has at least one hazardous region through which a risk of injury can be created in the event of an accident, and wherein the at least one attachment part is arranged next to the hazardous region of the at least one fender, wherein a connection is formed between the at least one attachment part and the at least one fender.

2. The body arrangement according to claim 1, wherein the connection between the at least one attachment part and the at least one fender is designed in the form of a form-fitting connection, a material connection or in the form of a movable connection.

3. The body arrangement according to claim 1, wherein the connection between the at least one attachment part and the at least one fender is configured to limit a relative movement between the at least one attachment part and the at least one fender in at least one spatial direction.

4. The body arrangement according to claim 2, wherein the form-fitting connection between the at least one attachment part and the at least one fender is designed to be permanent or temporary.

5. The body arrangement according to claim 1, wherein the hazardous region of the fender is designed as a fender tip directed in the direction of travel of the vehicle.

6. The body arrangement according to claim 1, wherein the at least one attachment part is designed as a front flap or as a lighting device of the vehicle.

7. A vehicle comprising at least one body arrangement according to claim 1.

8. The body arrangement according to claim 2, wherein the connection between the at least one attachment part and the at least one fender is configured to limit a relative movement between the at least one attachment part and the at least one fender in at least one spatial direction.

9. The body arrangement according to claim 3, wherein the form-fitting connection between the at least one attachment part and the at least one fender is designed to be permanent or temporary.

10. The body arrangement according to claim 2, wherein the hazardous region of the fender is designed as a fender tip directed in the direction of travel of the vehicle.

11. The body arrangement according to claim 3, wherein the hazardous region of the fender is designed as a fender tip directed in the direction of travel of the vehicle.

12. The body arrangement according to claim 4, wherein the hazardous region of the fender is designed as a fender tip directed in the direction of travel of the vehicle.

13. The body arrangement according to claim 2, wherein the at least one attachment part is designed as a front flap or as a lighting device of the vehicle.

14. The body arrangement according to claim 3, wherein the at least one attachment part is designed as a front flap or as a lighting device of the vehicle.

15. The body arrangement according to claim 4, wherein the at least one attachment part is designed as a front flap or as a lighting device of the vehicle.

16. The body arrangement according to claim 5, wherein the at least one attachment part is designed as a front flap or as a lighting device of the vehicle.
